(19) United States
(12) Patent Application Publication
(10) Pub. No.: US 2004/0161105 A1
(43) Pub. Date: Aug. 19, 2004

(54) Device for block level offset codebook mode operation and method thereof

(76) Inventors: Tae-Gon Park, Suwon-shi (KR); Kab-Joo Lee, Sungnam-shi (KR); Kyung-Wan Nam, Sungnam-shi (KR)

Correspondence Address: HARNESS, DICKEY & PIERCE, P.L.C., P.O. BOX 8910, RESTON, VA, 20195, US

(21) Appl. No.: 10/778,123

(22) Filed: Feb. 17, 2004

(30) Foreign Application Priority Data
Feb. 17, 2003 (JP) 2003-9789

(51) Int. Cl. H04L 9/00

(52) U.S. Cl. 380/28

(57) ABSTRACT

A method of block-level encryption/decryption for an offset codebook mode of operation during transmission/reception can include: receiving a frame of data to encrypted/decrypted; beginning to divide the frame into at least two packets before receipt of the frame is completed; beginning to divide at least one of the packets into two or more blocks before receipt of the frame is completed; releasing the blocks of the at least one packet for encryption/decryption before receipt of the frame is completed; and enciphering/deciphering the blocks of the at least one packet before receipt of the frame is completed.

### CROSS REFERENCE TO RELATED APPLICATION

This application claims the priority of Korean Patent Application No. 2003-09789, filed on 17 Feb. 2003 in the Korean Intellectual Property Office, the disclosure of which is hereby incorporated by reference in its entirety.

### BACKGROUND OF THE PRESENT INVENTION

The Data Encryption Standard (DES), Advanced Encryption Standard (AES), etc. have been proposed as standard algorithms for encryption. They define modes such as Electronic Codebook (ECB) mode, Cipher Block Chaining (CBC) mode, Output Feedback (OFB) mode and Cipher Feedback (CFB) mode. Recently, a COUNTER mode and an offset codebook (OCB) mode have been suggested. In OCB mode, a data network employs block cipher and various modes of operation which perform encryption using the block cipher.

The block cipher is an encryption method in which an encryption key and an algorithm are applied to each data block to create a ciphertext. In order to prevent the same blocks of plaintext from being coded into the same ciphertexts in one message, a ciphertext of a previous encryption block is applied to a next encryption block sequentially. For example, an initialization vector generated by a random number generator is combined with the first block of the plaintext such that that the same messages encrypted in the same time are prevented from creating the same ciphertext. In this manner, next blocks have different ciphertexts from previous encryption blocks.

A general encryption device performs decryption of a packet only after receipt of the entire packet is complete or encryption of the entire packet before of the encrypted packet is sent from/to a data network. Hence, a time delay corresponding to such decryption/encryption is introduced. In addition, a system resource used to perform such encryption/decryption represents computational overhead, so data throughput deteriorates. Further, if the encryption is performed before the frame to be sent is fragmented, it is impossible to achieve the encryption during transmission or decryption during reception of packets.

### SUMMARY OF THE PRESENT INVENTION

At least one embodiment of the present invention provides a method of (another embodiment providing a corresponding device for) block-level encryption/decryption for an offset codebook mode of operation during transmission/reception. Such a method can comprise: receiving a frame of data to encrypted/decrypted; beginning to divide the frame into at least two packets before receipt of the frame is completed; beginning to divide at least one of the packets into two or more blocks before receipt of the frame is completed; releasing the blocks of the at least one packet for encryption/decryption before receipt of the frame is completed; and enciphering/deciphering the blocks of the at least one packet before receipt of the frame is completed.

Additional features and advantages of the invention will be more fully apparent from the following detailed description of example embodiments, the accompanying drawings and the associated claims.

### BRIEF DESCRIPTION OF THE DRAWINGS

In the drawings:

FIG. 1 is a diagram illustrating elapsed packet receipt and decryption times for a decryption method using an offset codebook (again, OCB) mode according to an embodiment of the present invention and for a corresponding a method according to the Background Art, for the case that an unfragmented frame was transmitted as a packet;

FIG. 2 is a diagram illustrating elapsed packet receipt and decryption times for a decryption method using the OCB mode according to another embodiment of the present invention and for a corresponding method according to the Background Art, for the case the offset codebook mode is applied before the frame is fragmented;

FIG. 3 is a block diagram illustrating an encryption/decryption device for an offset codebook mode according to another embodiment of the present invention;

FIG. 4 is a more detailed block diagram illustrating an example configuration of the exception processing unit shown in FIG. 3, according to another embodiment of the present invention;

FIG. 5 is a more detailed block diagram illustrating an example configuration of the cryptoprocessing unit shown in FIG. 3, according to another embodiment of the present invention;

FIG. 6 is a flowchart illustrating decryption used for a reception process that handles exceptions, according to another embodiment of the present invention;

FIG. 7 is a flowchart illustrating in more detail an example of the header information reception routine shown in FIG. 6, according to another embodiment of the present invention;

FIG. 8 is a flowchart illustrating in more detail an example of the exception processing routine shown in FIG. 6, according to another embodiment of the present invention;

FIG. 9 is a flowchart illustrating in more detail an example of the offset codebook mode processing routine shown in FIG. 6, according to another embodiment of the present invention;

FIG. 10 is a flowchart illustrating in more detail an example of the last block processing routine shown in FIG. 6, according to another embodiment of the present invention;

FIG. 11 is a flowchart illustrating in more detail an example of the non-last block processing routine shown in FIG. 6, according to another embodiment of the present invention;

FIG. 12 is a flowchart illustrating encryption used for a transmission process, according to an embodiment of the present invention for reception;

FIGS. 13A-13B form a flowchart illustrating in more detail an example of the header information transmission routine shown in FIG. 12, according to another embodiment of the present invention;

FIG. 14 is a flowchart illustrating in more detail an example of the last block transmission routine shown in FIG. 12, according to another embodiment of the present invention;

FIG. 15 is a flowchart illustrating in more detail an example of the non-last block transmission routine shown in FIG. 12, according to another embodiment of the present invention;

FIG. 16 illustrates a BLOCKFRAG exception arising in an example implementation of another embodiment according to the present invention;

FIG. 17 illustrates MACFRAG exceptions arising in example implementations of another embodiment according to the present invention; and

FIG. 18 is a block diagram illustrating a configuration of a mobile system according to another embodiment of the present invention.

### DETAILED DESCRIPTION OF THE PRESENT INVENTION

Reference will now be made in detail to the preferred embodiments of the present invention, examples of which are illustrated in the accompanying drawings. However, the present invention is not limited to the embodiments illustrated herein after, and the embodiments herein are rather introduced to provide easy and complete understanding of the scope and spirit of the present invention.

Terms used below to describe some of the embodiments of the present invention will now be defined.

The term “fragmentation” means to divide transmitted data into fragments, e.g., to improve efficiency of data communication.

The term “frame” means a data unit that is intended to be transmitted. A frame may be so large that a decision is made to fragment the frame into smaller pieces (also known as fragments) before actual transmission takes place. If a size of a frame is larger than a fragment threshold, then the frame is fragmented/divided into fragments. If a size of a frame is not larger than the fragment threshold, then the frame is not fragmented.

The term “packet” means each piece of data generated by dividing/fragmenting a frame and, as such, is also referred to as a fragment.

The term “block” means a differently sized unit of data upon. A block is operated upon by a block cipher. A size of the block depends on the block cipher. A block is smaller than a packet (and typically a packet is smaller than a frame). Some block ciphers support several sizes. A size in units of bytes of the block will be referred to as BLOCKSIZE.

The term “body” means a payload part of a packet; it does not include a header part of the packet.

The term “message authentication code” (MAC) means a code used for ascertaining whether data is changed during data transmission. In general, the MAC is calculated frame by frame or packet by packet and attached to a rear portion of the frame or the packet. Variable MACSIZE represents a size in units of bytes of the MAC.

The term “nonce” means a value used with a key that is associated with a cipher and has a different value in each frame or packet with respect to the same key. Generally, the nonce is coupled with a frame or a packet and transmitted. The nonce may be coupled with the body or header. In at least one of the embodiments of the present invention described below, it is assumed (for ease of description) that the nonce is included in the header. Alternatively, the nonce can be coupled in one or more other ways with the frame or packet.

“Buffers” for example, of FIFO type, can be thought of as being placed at the front and at the rear of the offset codebook. Input contents are sequentially stored in a front buffer, and the offset codebook fetches necessary data and executes an algorithm. Then, the result is outputted to a rear buffer It is assumed (again, for ease of description) that the size of the buffers are unlimited.

“RoundUp(x)” function means to round up a value of x. In at least one of the embodiments of the present invention described below, it is assumed (again, for ease of description) that numbers are rounded up to the nearest one (or, in other words, 10°). If the value of x has a digit or digits below a decimal point (represent some fraction of one), then x+1 is output. If the value of x has no digit below a decimal point (representing no fraction of one), then x is output. Alternatively, other rounding schemes can be used.

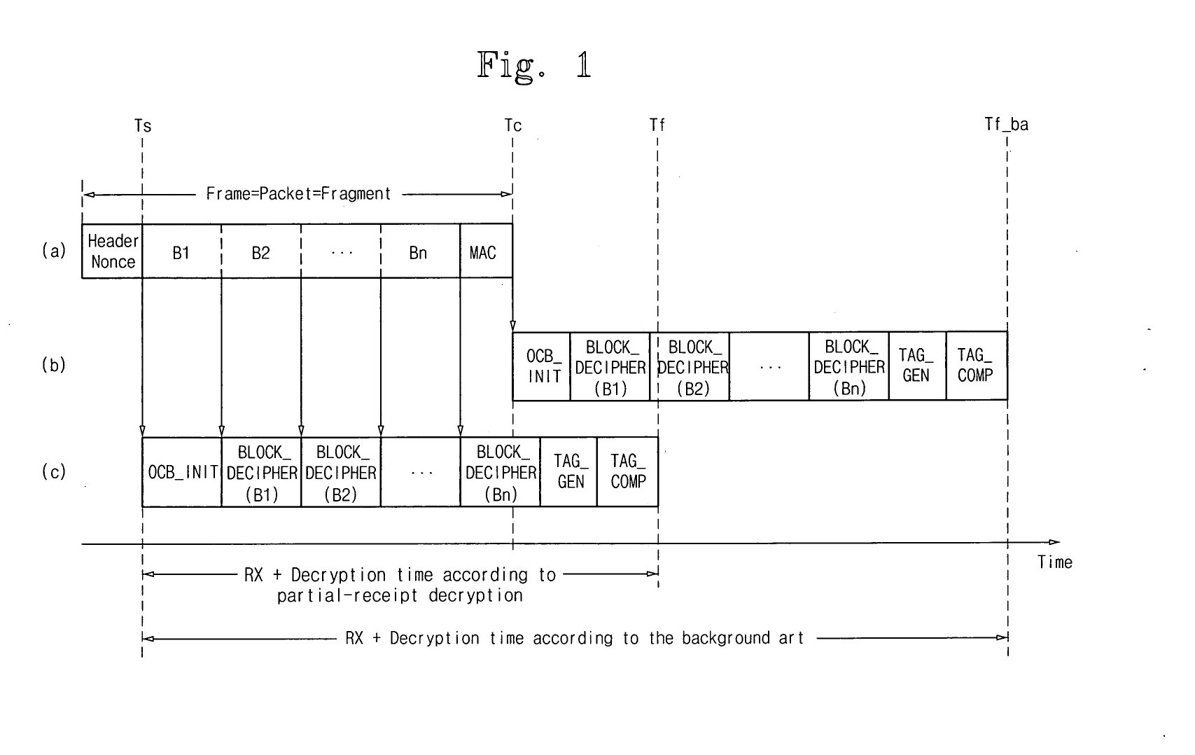

FIG. 1 is a diagram illustrating elapsed packet receipt and decryption times for an encryption method using an offset codebook (again, OCB) mode according to an embodiment of the present invention and such a method according to the Background Art, for the case that an unfragmented frame was transmitted as a packet; see timeline (a). Here, a reception operation will be described in terms of the same frame, same packet and same fragment.

As shown in timeline (a) of FIG. 1, receipt of a packet representing the unfragmented frame is complete as of a time Tc. Only as of time Tc, does OCB mode decryption according to the Background Art begin, finishing later at a time T_f ba, as indicated in timeline (b) of FIG. 1. As show in timeline (c) of FIG. 1, when an algorithm according to an embodiment of the present invention is applied, decryption (e.g., according to the OCB mode) is performed block by block during reception of the packet, beginning at a time Tb when the body of the packet starts to be received, and finishing later at a time Tf. Accordingly, it can be seen that time expended for packet receipt and decryption is reduced in timeline (c) as contrasted with the Background Art timeline (b) in which the OCB mode begins only after the entire packet is received.

According to the embodiment of the present invention corresponding to timeline (c) of FIG. 1, header information is first obtained to determine parameters (e.g., packet size, address, etc.) used by the OCB mode, and then the OCB mode is executed on a partial-receipt basis starting at time Ts when a first block B1 is inputted to a buffer. As depicted in timeline (c) of FIG. 1, if an execution speed of a block cipher is fast enough, then first block B1 can be completely decrypted while a next second block B2 is inputted to the buffer. Therefore, when the second block B2 is inputted to the buffer, the above-mentioned procedures are repeated. If all the received blocks B1 to Bn are completely processed, a tag generation TAG_GEN and a tag comparison TAG_COM can be performed to finish the decryption.

According to the embodiment corresponding to timeline (c) of FIG. 1, of the present invention, the OCB mode can be started almost at the same time when reception (and similarly, transmission) of a packet begins and the OCB mode can be finished almost at the same time when reception (and similarly transmission) of a packet ends. On the contrary, according to the Background Art corresponding to timeline (b), a significantly longer time for reception and decryption is required since the OCB mode begins only after all of the packet is received.

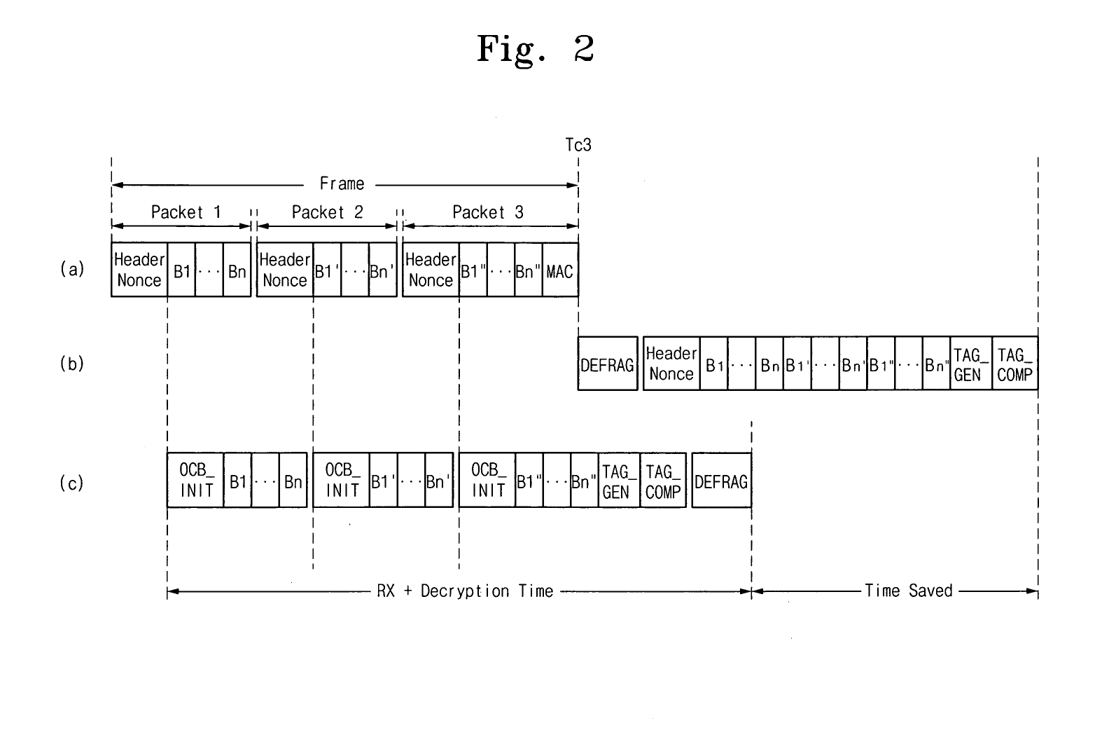

FIG. 2 is a diagram illustrating elapsed packet receipt and decryption times for a decryption method using the OCM mode according to another embodiment of the present invention and a corresponding method according to the Background Art, for the case the OCB mode is applied before the frame is fragmented. Here, the description will be made using the case that a frame having packets PACKET1 to PACKET3 was transmitted. Alternatively, sizes and fragmentations of frames other than what is illustrated in FIG. 2 can be used.

As shown in timeline (a) of FIG. 2, receipt of packets PACKET1, PACKET2 and PACKET3 representing the fragments of the transmitted frame is complete as soon as reception of packet PACKET3 is complete at a time Tc3. OCB mode decryption according to the Background Art begins only after receipt of all of the packets, i.e., begins at time Tc3. However, if partial-receipt decryption according to an embodiment of the present invention is employed as indicated by timeline (c), then, the OCB mode can be performed block by block B1 to Bn while receiving each of the packets PACKET1-PACKET3. The result shown in timeline (c) is that the OCB mode for each packet is completed almost at the same time when reception of each packet is completed. Defragmentation DEFRAG in timeline (c) is performed after decryption of PACKET3 is complete, thereby completing the decryption of the frame.

In the embodiment corresponding to timeline (c) of FIG. 2, some problems (also referred to as exceptions) can be caused due to fragmentation, as will be discussed below. Accordingly, also below are presented techniques for dealing with such exceptions relative to operation of the OCB mode.

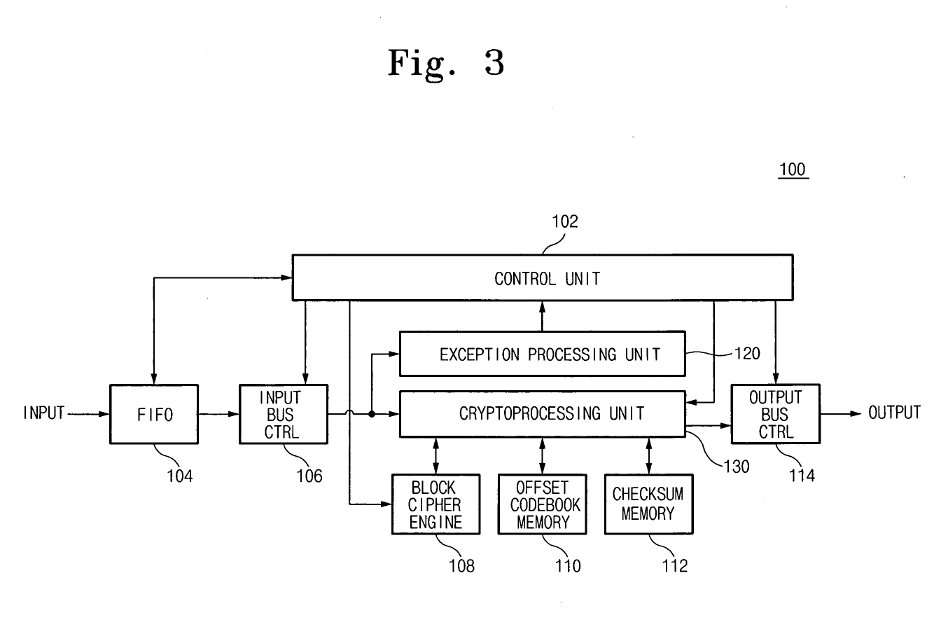

Hereinafter, a configuration of an encryption device and procedures of the OCB mode of operation according to embodiments of the present invention will be described in detail with reference to FIGS. 3 to 17.

FIG. 3 is a block diagram illustrating a configuration of an encryption/decryption (E/D) device 100, according to another embodiment of the present invention.

Referring to FIG. 3, E/D device 100 includes a control unit 102, an exception processing unit 120 and a cryptoprocessing unit 130. In addition, E/D device 100 further includes an input buffer (e.g., of FIFO type) 104, an input bus controller 106, an output bus controller 114, a block cipher engine 108, an offset codebook memory 110, and a checksum memory 112.

Input buffer 104, e.g., can be arranged for FIFO type buffering. Input buffer 104 receives data for encryption or decryption in the form of a signal INPUT and then buffers the received data, provides control unit 102 with size information regarding the stored data, and delivers stored data to input bus controller 106.

Input bus controller 106 routes the data transferred from input buffer 104 to exception processing unit 120 and cryptoprocessing unit 130 under the control of control unit 102.

Control unit 102 receives the size information regarding the stored data from input buffer 104, and is informed whether an exception will occur by exception processing unit 120. Control unit 102 can include a friite state machine (FSM) that can be used for dealing with an exception, e.g., by receiving the corresponding information and driving other units 106, 108 and 120 in a manner suitable for dealing with the exception.

In order to encrypt/decrypt the data stored in input buffer 104 on a block by block basis, control unit 102 controls input bus controller 106 to release stored data to cryptoprocessing unit 130 in increments of blocks whose respective sizes do not exceed BLOCKSIZE. The OCB mode is applied at a block level rather than at a packet level (as is done according to the Background Art). Control unit 102 transmits an encryption key to block cipher engine 108 and indicates whether the key is to be used for an encryption or a decryption.

Output bus controller 114 receives a control signal from control unit 102, receives the data processed by cryptoprocessing unit 130 and outputs the cryptoprocessed data as signal OUTPUT.

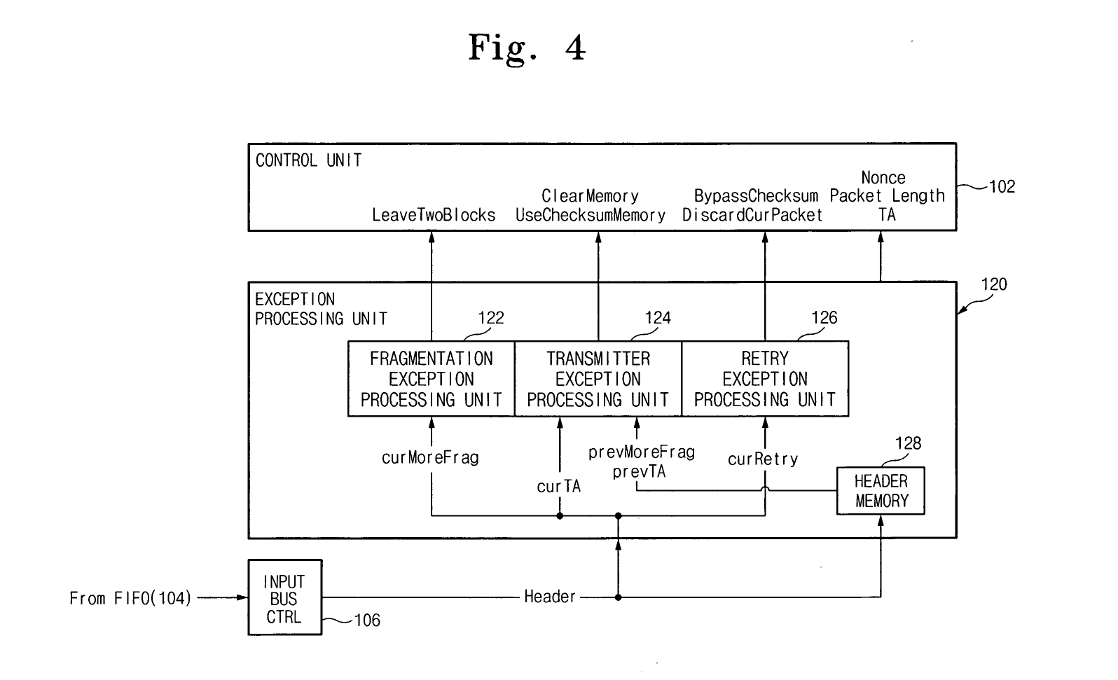

Exception processing unit 120 determines whether an exception will occur based upon header information of the packet to be transmitted (encryption scenario) or the received packet (decryption scenario). If an exception will occur, information as to the impending exception is provided to control unit 102, e.g., as shown in FIG. 4. FIG. 4 is a block diagram illustrating in more detail an example of exception processing unit 120, according to another embodiment of the present invention.

Specifically, as shown in FIG. 4, exception processing unit 120 includes a fragmentation exception processing unit 122, a transmitter exception processing unit 124, a retry exception processing unit 126, and a header memory. Exception processing unit 120 can be the first to receive the header information of a packet from input bus controller 106. More particularly, e.g., processing units 122 to 126 receive a MOREFRAG bit, the transmitter address TA and a retry bit, respectively of the header information. Processing units 122 to 126 determine whether an exception will occur. If it is determined that an exception will occur, then the corresponding processing unit which recognized the impending exception informs control unit 102 of the impending exception so that control unit 102 can adaptively control encryption/decryption according to the exception. Processing units 122 to 126 can store the entire header information or merely the transmitter address and a MOREFRAG bit of the header information into header memory 128 and use the stored header information to ascertain whether an exception (whose solution uses at least a part of the packet to be inputted next) will occur. Exception processing unit 120 transmits a nonce extracted from the header information, a packet length and a transmitter address to control unit 102.

According to an embodiment of the present invention, if the OCB mode is performed on a packet representing a fragment of a frame, the time necessary for block-level encryption can be reduced relative to the case in which the OCB mode is performed at the packet-level. Consequently, the operation speeds of the E/D device and the system including the E/D device can be improved relative to the Background Art. Again, exceptions may occur during block-level encryption/decryption; but solutions are suggested below. Exceptions that can arise when the OCB mode is performed on a packet (representing part of a fragmented frame) include a fragmentation exception, a transmission exception and a retry exception.

More particularly, a fragmentation exception refers to fragmenting that occurs within a fragment due to dividing a fragment into blocks. In other words, not only can a frame be fragmented, but fragmentation of a block is also possible. For simplicity of description, fragmentation of a block will be described as splintering the block into splinters. Splintering occurs when the size of a fragment (in bytes) does not equal an integer multiple of the size of a block, namely BLOCKSIZE (in bytes). If splintering occurs, typically the last block of the fragment is the block that becomes splintered. A block that is splintered cannot be encrypted or decrypted in the typical manner; this can be dealt with, e.g., by delaying encryption/decryption of the splintered block until operation begins upon the next packet of the same or different frame. This type of exception is referred to as a BLOCKFRAG exception.

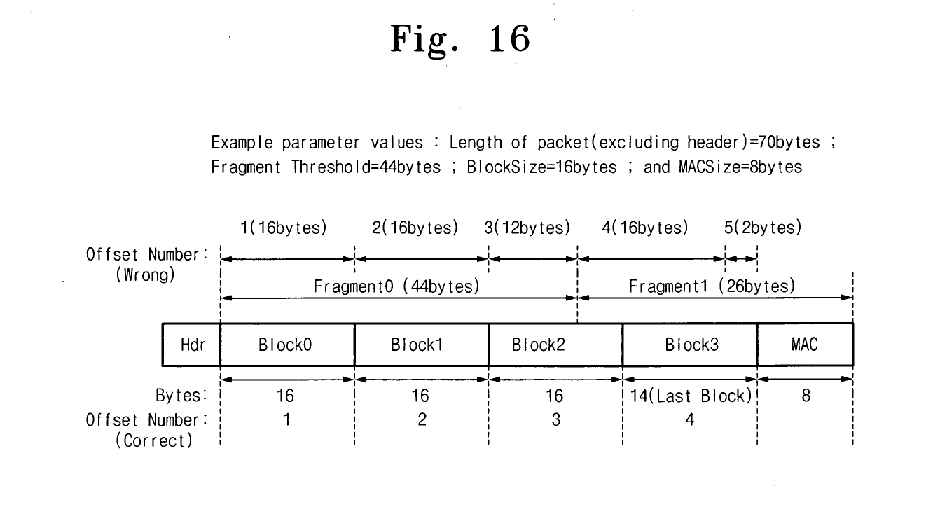

FIG. 16 illustrates a BLOCKFRAG exception arising in an example implementation according to another embodiment of the present invention. In FIG. 16, if the lengths of the frame (excluding the header information hdr), fragment threshold, BLOCKSIZE and MAC size are 70 bytes, 44 bytes, 16 bytes and 8 bytes respectively, then the frame is fragmented into first and second packets FRAGMENT0 and FRAGMENT1 that are 44 bytes and 26 bytes in size, respectively. Since BLOCKSIZE is 16 bytes and the size of packet FRAGMENT0 is not an integer multiple of BLOCKSIZE, third block BLOCK2 (which happens to be the last block) of first packet FRAGMENT0 is splintered so that the last 12 bytes of the first packet FRAGMENT0 cannot be encrypted or decrypted at that moment during transmission and reception, respectively.

A frame is fragmented without deference to the message authentication code (MAC) frequently found at the end of a packet or frame. Fragmentation can arise at a location within the MAC. When a fragmented frame is encrypted or decrypted, it is impossible to distinguish which block is the last block until the last fragment is received. This type of exception is referred to as a MACFRAG exception. In the case of reception, the last fragment is received and the MACFRAG exception occurs when the body size of the packet representing the last fragment is less than MACSIZE. In the case of transmission, the last fragment is received and the MACFRAG exception occurs when the body size of the last fragment is less than MACSIZE. If the fragment threshold is greater than or equal to MACSIZE, such conditions are satisfied. In general, since MACSIZE is less than BLOCKSIZE and the fragment threshold is greater than or equal to BLOCKSIZE, such conditions can be used.

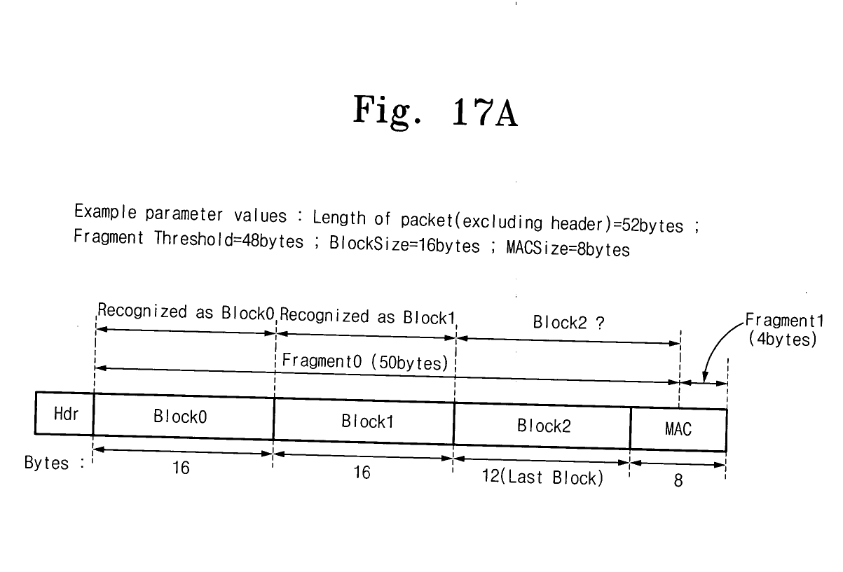

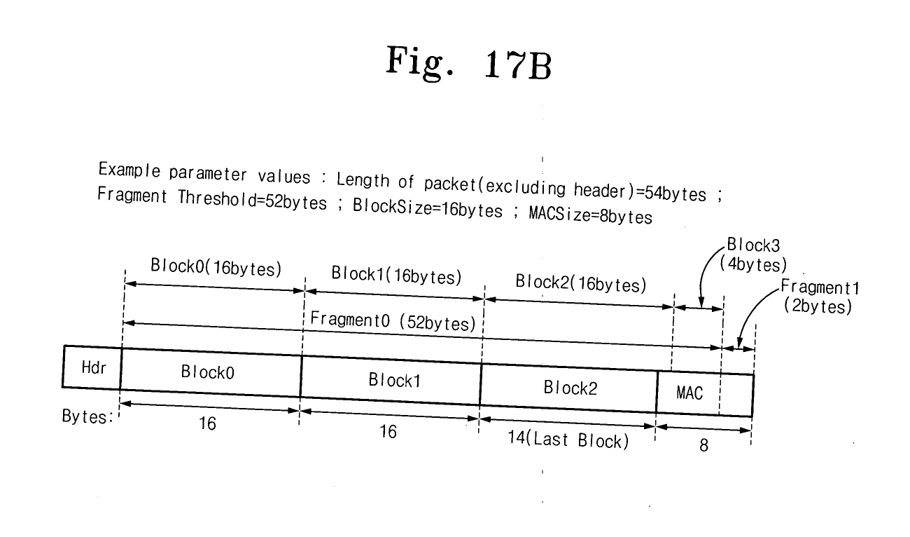

FIGS. 17A and 17B illustrate MACFRAG exceptions arising in example implementations of another embodiment of the present invention. In FIG. 17A, for the case that the lengths of the frame (excluding the header information), fragment threshold, BLOCKSIZE and MACSIZE are 52 bytes, 48 bytes, 16 bytes and 8 bytes, respectively, then the sizes of first packet FRAGMENT0 and second packet FRAGMENT1 are 48 bytes and 4 bytes, respectively. The third block BLOCK2 of first fragment FRAGMENT0 has 12 bytes of data, leaving four bytes that correspond to a portion of the MAC. Because a whole MAC, but not a portion thereof, can be encrypted/decrypted, encryption/decryption of first packet FRAGMENT0 cannot be completed until after receiving a portion of second packet FRAGMENT1. This type of exception is referred to as a MACFRAG exception. In other words, if MACSIZE is less than the BLOCKSIZE, the header information is received in reception, and if the present packet does not represent the last block of the fragment, then the last two blocks are stored in a buffer without being decrypted.

In FIG. 17B, if the lengths of the frame (excluding the header information), fragment threshold, BLOCKSIZE and MACSIZE are 54 bytes, 52 bytes, 16 bytes and 8 bytes, respectively, then the size of the second to last block BLOCK1 is BLOCKSIZE (16 bytes) and the size of the last block BLOCK2 is 14 bytes. The circumstances of FIG. 17b describe a BLOCKFRAG exception, which can be dealt with by retaining the last block in the buffer. But a reason to retain two blocks is that second block BLOCK2 can be made equal in size to BLOCKSIZE if it is made to include a portion of the MAC when a sum (six bytes) equaling the size (four bytes) of the last block BLOCK3 in packet FRAGMENT0 plus the size (two bytes) of the next (and here only) packet in packet FRAGMENT1 does not equal MACSIZE. Accordingly, if the next packet, namely packet FRAGMENT1, is not the last packet, then a packet will be received subsequently to packet FRAGMENT1. If the next packet FRAGMENT1 is the last fragment, then the size (four bytes) of the previous retained block BLOCK3 and the size of the next message protocol data unit (MPDU) are summed. The MACSIZE from the last packet is treated as a MAC and the remaining front portion is a sum of blocks and the last block or simply the last block taken alone. When MACSIZE is greater than or equal to BLOCKSIZE, blocks are retained according to the value (RoundUp(MACSIZE/BLOCKSIZE)+1) obtained by dividing MACSIZE by BLOCKSIZE, rounding up and adding one; and so the problem can be solved.

In the case of the transmission, the fragment threshold can be set as a multiple of the MACSIZE. In other words, when the MAC is included in the header information, a MACFRAG exception does not occur. So only the last block is necessarily retained in the buffer upon occurrence of a BLOCKFRAG exception; and so the problem can be solved.

Now the discussion turns in detail toward the transmission exception type of exception. Such an exception occurs during reception. If packets are not received sequentially, namely without there being an interposed packet transmitted from another source (transmitter) inserted in the midst of the received packets, then the value of a checksum register becomes corrupted. A transmission exception occurs when the previously received packet is not the last fragment of a frame and the source of the currently received packet is different from that of the previously received packet.

To deal with a transmission exception, since the already received packets are generally removed (though the last one or two blocks of the previously received packet can sometimes be retained in the buffer), e.g., the buffer can be flushed. This method is suitable to be employed with burst transmissions of fragments, e.g., as used in a wireless LAN adhering to the IEEE 802.11 standard. This approach can be used because (typically) a packet is rarely received from a second source while receiving fragments from a first source. But if one or more packets are frequently received from a second or other source while receiving packets from a first source, then the checksum values associated with received packets from the first source are also stored in addition to the received packets so that previous checksum values associated with packets previously received from the first source can be used when reception of packets from the first source resumes (after an interruption represented by receipt and encryption/decryption of packets received from the second or other source).

Finally, discussion in detail turns to the retry exception type of exception. A retry is executed when an error occurs in communication. According to at least one embodiment of the present invention, since the checksum is calculated for each block and is used by the last tag generator, the checksum should be recovered if a retry is executed. The retry exception can occur when the received packet does not represent the last fragment, the currently received packet is a retry packet, the transmitted packet represents a fragment of a frame and an error occurs in transmission.

To deal with a retry exception according to at least one embodiment of the present invention, the OCB mode is not performed upon the retry packet (the retry packet is discarded) if the currently-received packet is the same as an already received packet due to there having been a retry. Otherwise, the OCB mode is operated. Additionally, it is ascertained during transmission whether the packet is a retry packet. If so, the checksum is calculated and a bypass is performed while the OCB mode is operated.

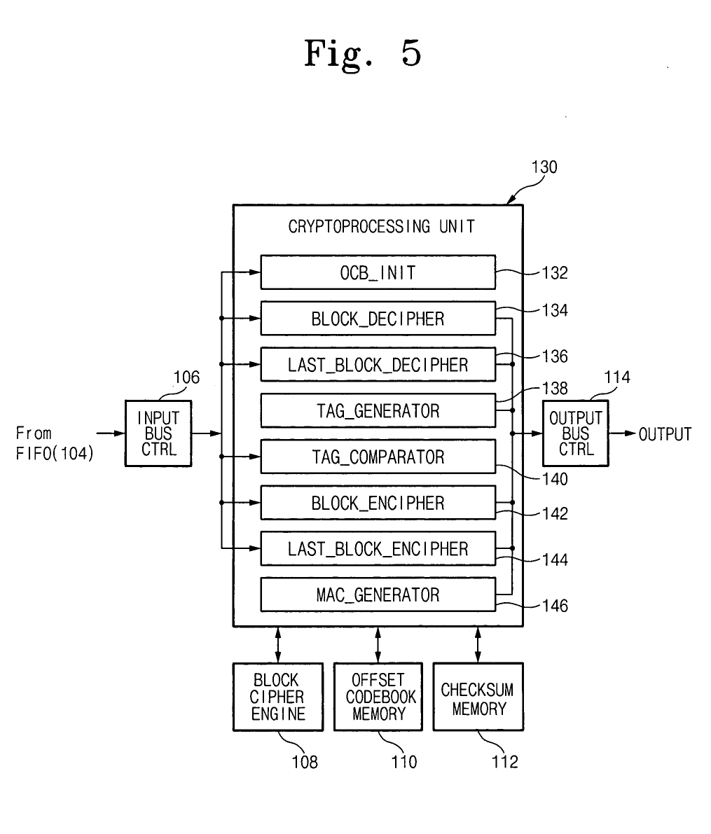

Cryptoprocessing unit 130 generates the offset codebook to encrypt or decrypt data inputted during transmission and reception and generates a tag and a MAC. FIG. 5 is a block diagram illustrating in more detail an example of cryptoprocessing unit 130, according to another embodiment of the present invention. In FIG. 5, cryptoprocessing unit 130 includes an offset codebook initiator (OCB_INIT) 132, a block decipher (BLOCK_DECIPHER) 134, a last block decipher (LAST_BLOCK_DECIPHER) 136, a tag generator (TAG_GENERATOR) 138; a tag comparator (TAG_COMPARATOR) 140; a block encipher (BLOCK_ENCIPHER) 142; a last block encipher (LAST_BLOCK_ENCIPHER) 144; and a message authentication code (MAC) generator (MAC_GENERATOR) 146.

Cryptoprocessing unit 130 uses offset codebook initiator 132, block decipher 134, last block decipher 136, tag generator 138 and tag comparator 140 for decryption, and uses offset codebook initiator 132, block encipher 142, last block encipher 144, tag generator 138 and MAC generator 146 for encryption.

Offset codebook initiator 132 operates during transmission and reception, generates a default offset codebook and stores the offset codebook in offset codebook memory 110. Offset codebook initiator 132 also generates the value of initial offset codebook entry OFFSET0 by using a nonce, and stores the value of entry OFFSET0 in offset codebook memory 110 (e.g., a register).

Block decipher 134 operates during reception upon blocks other than the last block of a frame, generates the next entry OFFSET(i+1) in the offset codebook by using the previous entry OFFSET(i) and stores the value of next entry OFFSET(i+1) in memory 110. Block decipher 134 decrypts the received block and updates the checksum value for generating a tag stored in checksum memory 112. Last block decipher 136 is similar to block decipher 134 but is adapted to operate upon the last block of the frame.

Tag generator 138 operates during reception, and generates tags by using the checksum updated by block decipher 134 and last block decipher 136.

Tag comparator 140 operates during reception, compares the generated tag with the MAC, and determines whether an error has occurred during the transmission. For example, if the tag and the MAC are different from each other, then an error has occurred.

Block encipher 142 operates during transmission upon blocks other than the last block of a frame, generates the value of the next entry OFFSET(i+1) in the offset codebook using the previous offset entry OFFSET(i), and stores the next entry OFFSET(i+1) in memory 110. Block cipher 142 encrypts blocks other than the last block of a frame to be transmitted, and updates a checksum for generating a MAC.

Last block cipher 144 operates during transmission upon the last block of a frame, generates the next entry OFFSET(i+1) in the offset codebook by using the previous entry OFFSET(i), and stores the next entry OFFSET(i+1) in memory 110. Last block cipher 144 encrypts the last block of a frame to be transmitted, and updates a checksum for generating a MAC.

MAC generator 146 operates during transmission, and generates a MAC by using a checksum updated by block cipher 142 and last block cipher 144.

Referring to FIG. 3, block cipher engine 108 receives an encryption key from control unit 102 and interacts with cryptoprocessing unit 130 by using a standard algorithm (e.g., DES, AES, etc.) to perform encryption or decryption.

Offset codebook memory 110 stores the offset codebook generated by cryptoprocessing unit 130.

Checksum memory 112 is a memory used during the processing of a transmission exception and stores a set that includes a transmission address and checksum value. Accordingly, when cryptoprocessing unit 130 receives the previous packet and a packet from another transmitter, cryptoprocessing unit 130 checks for a difference in addresses by using the corresponding address from checksum memory 112.

Accordingly, in E/D device 100, input bus controller 106 transfers data of size BLOCKSIZE from input buffer 104 to units 120 and 130 under control by control unit 102. Units 120 and 130 process the data of size BLOCKSIZE and then transmit the data to output bus controller 114. Units 132-138 and 142-146 operate using block cipher engine 108. The offset codebook generated by offset codebook initiator 132 is stored in offset codebook memory 110 and used by block decipher 134, last block decipher 136, block cipher 142 and last block cipher 144 when they generate values of entries in the codebook. Tag generator 138 and MAC generator 146 calculate the value inputted to block cipher engine 108.

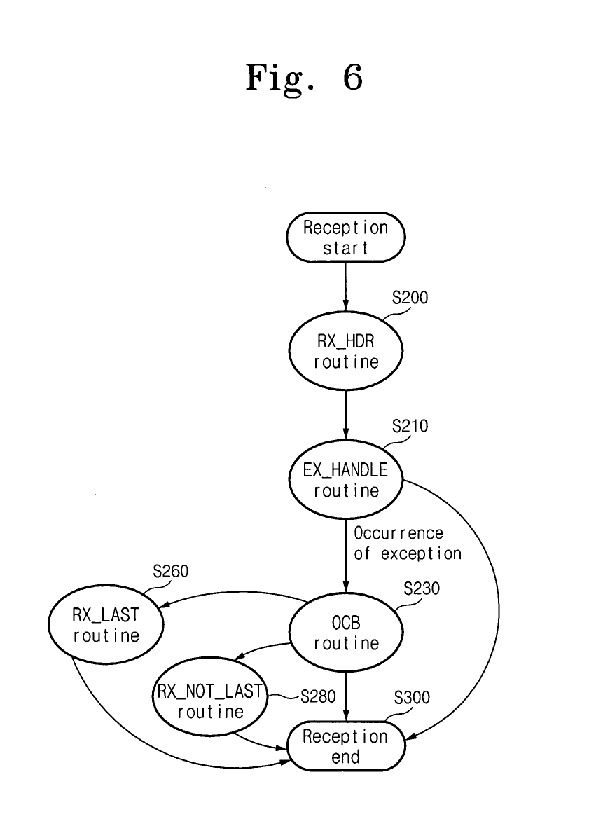

Aspects of transmission and reception that, e.g., can be carried out by E/D device 100, of the encryption device will be described with reference to FIGS. 6 to 15, according to at least one other embodiment of the present invention.

Again, the byte length of a MAC is referred to as MACSIZE, which is typically a constant. A variable BYTESLEFT indicates how many bytes remain in the buffer after the OCB mode is performed on the previous packet. The variable BYTESLEFT is dynamically updated. Another variable BYTESINBUFFER indicates how many bytes remain in the buffer currently. The variable BYTESINBUFFER is dynamically updated by a device that puts data in buffer 104, for example, a modem in the case of reception. Since the data can be received continually while operating in the OCB mode, variable BYTESINBUFFER can be changed without the change necessarily reflecting draining of the buffer by OCB mode operation.

FIG. 6 is a flowchart illustrating decryption used for a reception process that handles exceptions of the sort mentioned above, according to the present invention. Such a process can be programmed in a memory (not shown) of an E/D device, e.g., device 100. Such a program can run under the control of a control unit in the E/D device.

Referring FIG. 6, at step S200, a routine RX_HDR for receiving the header information is performed. If it is determined that at least one of the exceptions (mentioned above) will occur, then an exception processing routine EX_HANDLE is performed at step S210. Otherwise, the receiving process is terminated at step S300.

At step S230, an OCB mode processing routine OCB is performed corresponding to the particular type of exception. It is ascertained whether the block to be processed is the last block. If so, then flow goes to step S260, where a last block receiving routine RX_LAST is performed. If not, then flow goes to step S280, where a receiving routing RX_NOT_LAST is performed. After each of steps S260 and S280, flow ends at step S300.

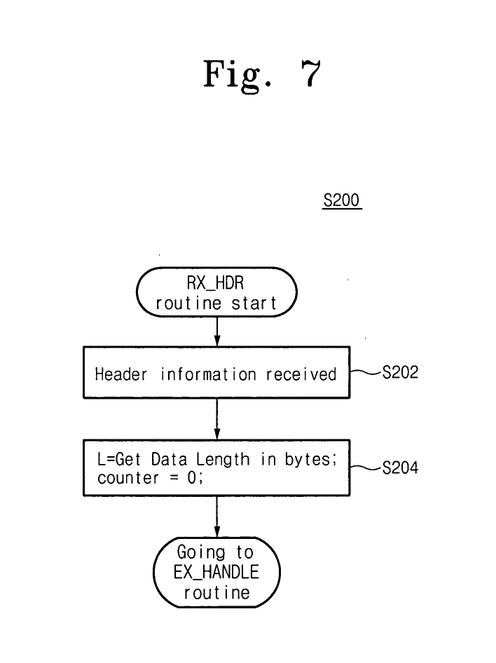

More particularly, header information receiving routine S200 receives the header information at step S202, e.g., as shown in FIG. 7. FIG. 7 is a flowchart showing in more detail an example of routine RX_HDR of step S200, according to another embodiment of the present invention. Size information L of the data can be obtained from the received header information at step S204 and a variable COUNTER can be initialized. Data size information L indicates the length of the packet (excluding the header) in units of bytes. In general, the packet length is stored in the header. Here, it is assumed that a nonce is also included in the header. A default value, e.g., zero, for the number of blocks into which the received packet can be divided is stored in a variable COUNTER.

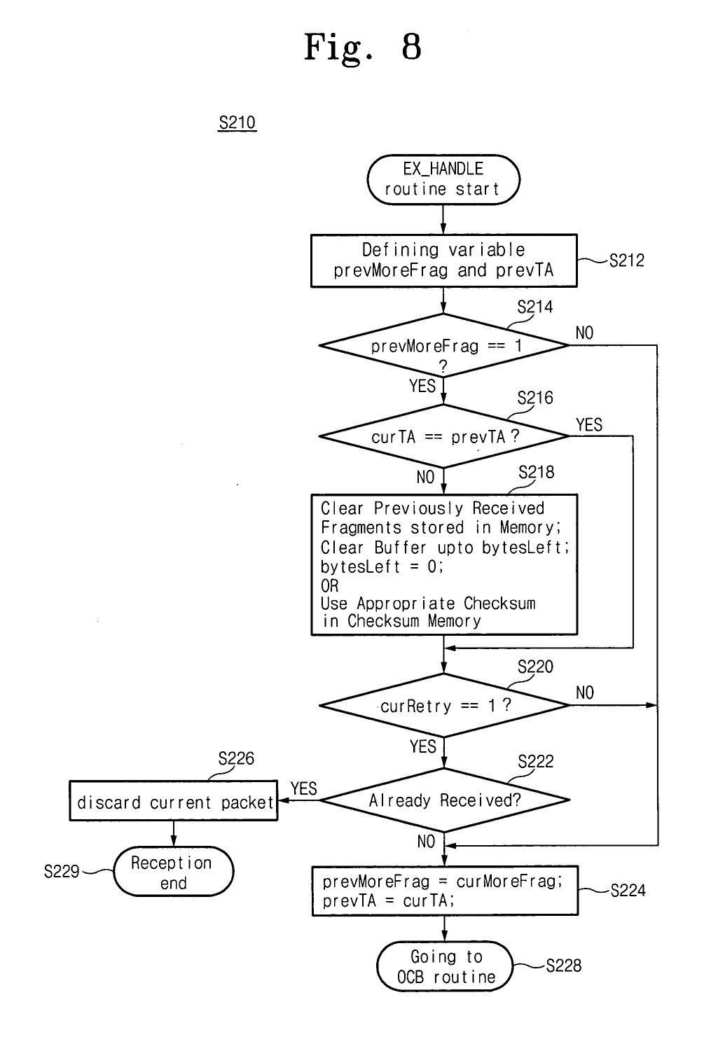

Again, after step S200, exception processing routine EX_HANDLE (step S210) is performed. FIG. 8 is a flowchart showing in more detail an example of routine EX-HANDLE of step S210, according to another embodiment of the present invention. At step S212, variables for storing information regarding the previous packet are defined. For example, a variable PREVMOREFRAG can store information on whether the previously received packet is the last fragment; and a variable PREVTA can store the address information of the transmitter.

At step S214, if variable PREVMOREFRAG is not 1, then an exception has not occurred since the previous packet is the last fragment, which is understood as the previous packet not having a relation to the currently received packet. If no exception has occurred, then flow goes from step S214 to step S224 so these two variables are updated for the next packet, and then routine S210 is terminated at step S228. In other words, the values of a variable CURMOREFRAG and a variable CURTA storing the information on whether the received packet is the last fragment and the transmitter address information, respectively, are used as the values of variables PREVMOREFRAG and PREVTA for the next packet.

At step S214, if variable PREVMOREFRAG is 1, then the previous packet is not the last fragment and flow goes to decision step S216. At decision step S216, it is determined whether the transmitter address PREVTA of the previous packet is the same as the transmitter address CURTA of the current packet.

At step S216, if the two transmitter addresses are different from each other, then it is determined that a transmission exception has occurred, and flow goes out the “NO” output of step S216. Next, at step S218, all the packets received from the previous variable PREVTA are removed from the memory and contents of the buffer are removed in an amount sufficient so that an amount corresponding to variable BYTESLEFT remains. Variable BYTESLEFT is then initialized, e.g., to a value of zero. Here, variable BYTESLEFT indicates the bytes remaining after processing the previous packets in the buffer according to the OCB mode. Alternatively at step S216, if the two transmitter addresses are the same, then an exception has not occurred, and flow goes out the “YES” output of step S216 to decision step S224 (discussed below).

Subsequently, at decision step S220, it is determined whether the currently received packet is indicated as being a retry packet. If so, then flow goes to decision step S222. Generally, the header information of the transmitted retry packet includes the information indicating whether the packet is a retry packet.

At decision step S222, it is determined whether the current received packet actually has been received. If so, then flow goes to step S226, where the currently received packet is removed/discarded. Subsequently, flow is terminated at step S229. Further processing waits until the next packet is received.

Alternatively at decision steps S220 or S222, if the received packet is a new packet (or, in other words, does not as a practical matter represent a retry packet), then flow goes to step S224, where variables are updated. Subsequently at step S228, flow jumps to routine OCB of step S320.

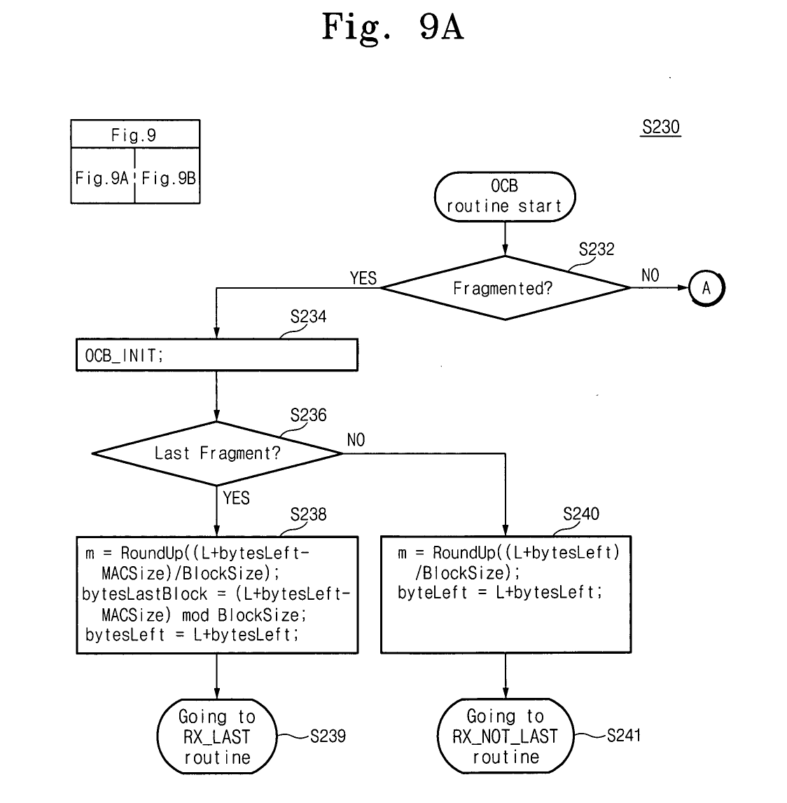

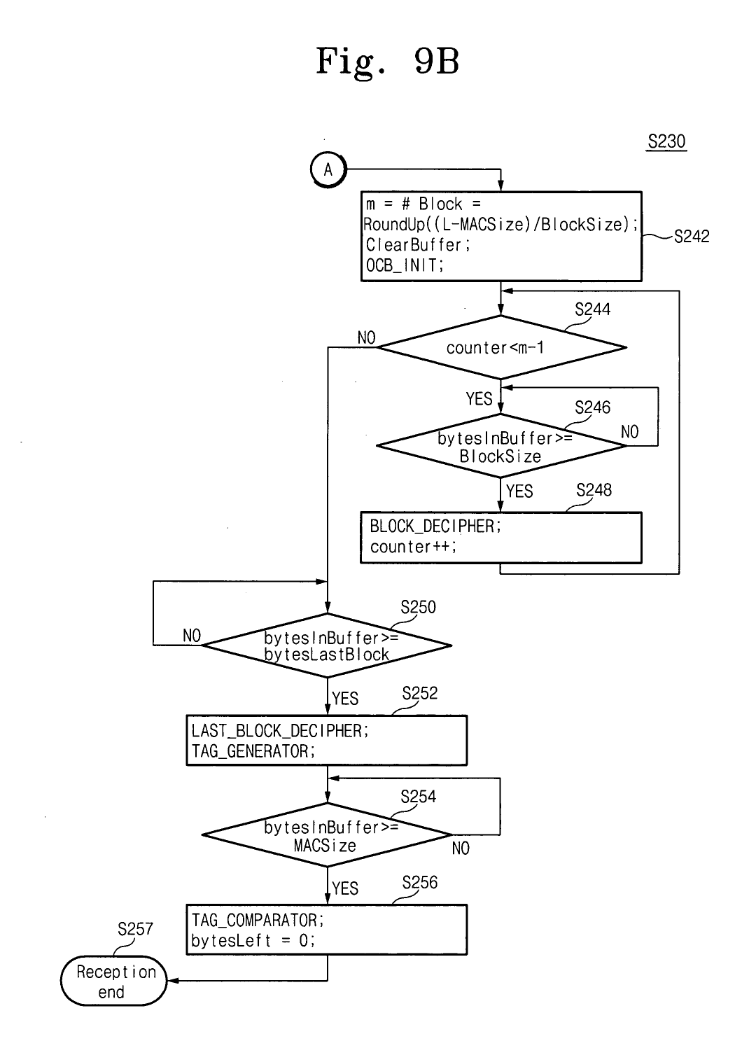

FIGS. 9A and 9B together are a flowchart showing in more detail an example of routine OCB of step S230 of FIG. 6, according to an embodiment of the present invention. Here, FIG. 9A relates to processing of a packet representing a fragment of a frame and FIG. 9B relates to processing of an unfragmented frame.

Referring to FIG. 9A, flow begins at decision step S232, where it is determined whether the currently received packet represents a fragment of a frame or the entire frame. In other words, if the currently received packet is a frame fragment, then the flow goes to step S234. If not, the flow goes to step S242 of FIG. 9B (to be discussed in detail below). At step S234, an OCB mode initialization function is performed and the OCB mode is made ready.

After step S234, it is determined at decision step S236 whether the received packet represents the last one of the fragments. If so, then flow goes to step S238, where the number m of blocks is determined, the value (length) for variable BYTESLASTBLOCK (in units of bytes) of the last block is calculated, and the number of bytes remaining in the buffer and the number of bytes making up the packet to be received are summed and stored in variable BYTESLEFT. Subsequently at step S239, flow jumps to the last block receiving routine (again RX_LAST) of step S260, to be discussed below. But if the currently received packet is determined at decision step S312 not to represent the last fragment, then flow goes to step S240. Step S240 is like step S238 except, e.g., that MACSIZE is not a factor in the equation for m. Subsequently at step S241, flow jumps to the routine RX_NOT_LAST of step S350, to be discussed below.

But if it is determined at decision step S232 that the currently-received packet does not represent the last fragment, then (again) flow goes to step S242 of FIG. 9B, where a number m of blocks in the received packet is determined. The number m represents the size of the received packet and is obtained by rounding up a difference (formed by the subtraction of MACSIZE from L) that is divided by BLOCKSIZE, namely RoundUp((L−MACSIZE). Since the previously received packet may have been retained in the buffer, the buffer is flushed, the OCB mode initialization function is performed and the OCB mode is made ready. Flow goes from step S242 to decision step 244.

At decision step S244, it is determined whether the value of variable COUNTER is less than m−1. If so, then flow goes to decision step S246. At decision step S246, it is determined whether the length of data in the buffer, e.g., the value of variable BYTESINBUFFER, is greater than or equal to BLOCKSIZE. If so, then flow goes to step S248, where the block decipher function is performed to decrypt blocks. Subsequently, the value of variable COUNTER is increased by 1 and then flow goes back to step S244. Steps S246-S248 are repeated until the value of variable COUNTER becomes equal to m−1.

If variable COUNTER equals m−1 at decision step S244, then flow goes to step S250. At decision step S250, it is determined whether variable BYTESINBUFFER is greater than or equal to variable BYTESLASTBLOCK. If so, then flow goes to step S252, where the last block cipher function and tag generating function are performed. Subsequently, at decision step S254, it is determined whether variable BYTESINBUFFER is greater than or equal to variable MACSIZE. If so, then flow goes to step S256, where the tag comparison function is performed and variable BYTESLEFT is initialized. Then the reception is terminated at step S257 and receipt of the next packet is awaited.

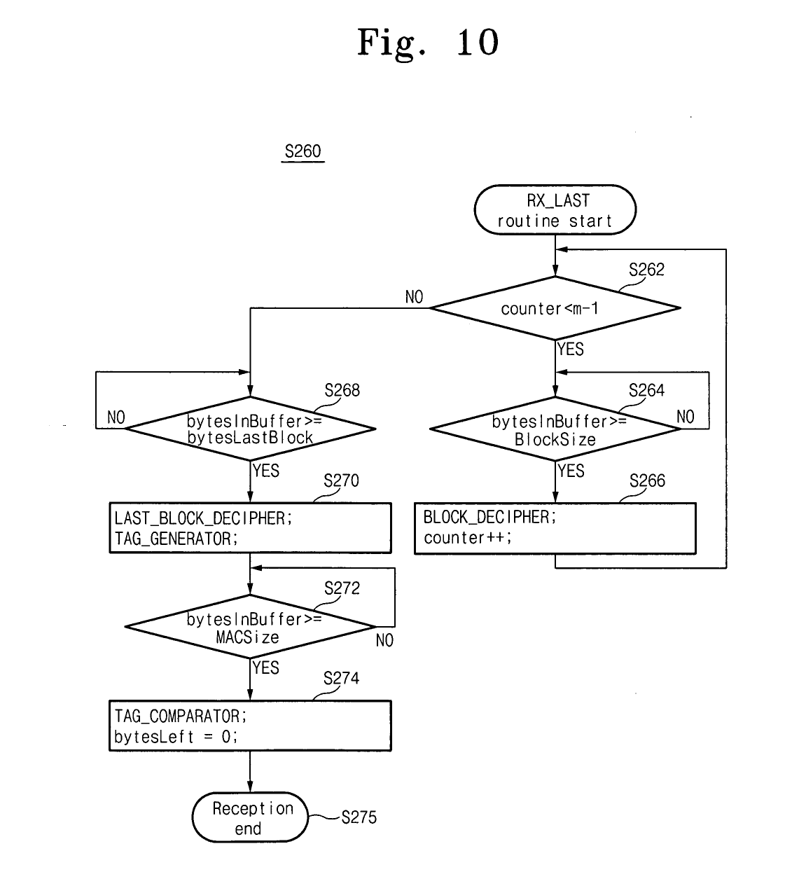

FIG. 10 is a flowchart showing in more detail an example of routine RX_LAST of step S260, according to another embodiment of the present invention. Flow begins in FIG. 10 at decision step S262, where it is determined whether variable COUNTER is less than m−1. If so, then flow goes to decision step S264. At decision step S264, it is determined whether variable BYTESINBUFFER is greater than or equal to variable BLOCKSIZE. If so, then flow goes to step S266, where the block decipher function is performed and variable COUNTER is increased by 1. Subsequently, flow goes back to step S262 S0 that steps S262-S266 are repeated until variable COUNTER becomes equal to m−1.

If variable COUNTER equals m−1 at step S262, the flow goes to step S268. At decision step S268, it is determined whether variable BYTESINBUFFER is greater than or equal to variable BYTESLASTBLOCK. If so, then flow goes to step S270, where the last block decipher function and the tag generating function are performed. Flow goes from step S270 to decision step S272.

At decision step S272, if variable BYTESINBUFFER is greater than or equal to the variable MACSIZE, then flow goes to step S274, where the tag comparison function is performed and variable BYTESLEFT is initialized. Subsequently, the reception is terminated at step S275 and receipt of the next packet is awaited.

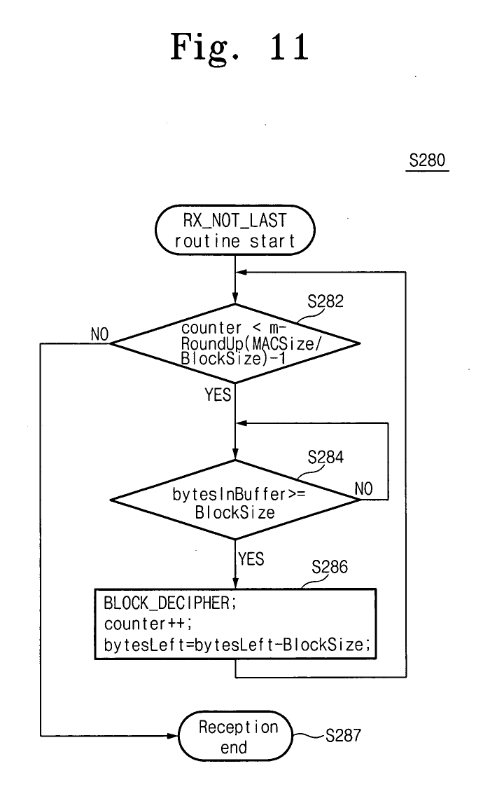

FIG. 11 is a flowchart showing in more detail an example of routine RX_NOT_LAST of step S280, according to another embodiment of the present invention. Flow in FIG. 11 begins at decision step S280, where it is determined whether variable COUNTER is less than the difference m−1 RoundUp(MACSIZE/BLOCKSIZE) −1. If so, then flow goes to decision step S284. At decision step S284, it is determined whether variable BYTESINBUFFER is greater than or equal to variable BLOCKSIZE. If so (at decision step S284), then flow goes to step S286, where the block decipher function is performed, and variable COUNTER is increased by 1, variable BYTESLEFT is decreased by variable BLOCKSIZE. Flow goes from step S286 back to step S282 so that steps S282-S286 are repeated. But if variable COUNTER is found equal to the difference m−1 RoundUp(MACSIZE/BLOCKSIZE) −1 at decision step S282, then the reception is terminated at step S287 and receipt of the next packet is awaited.

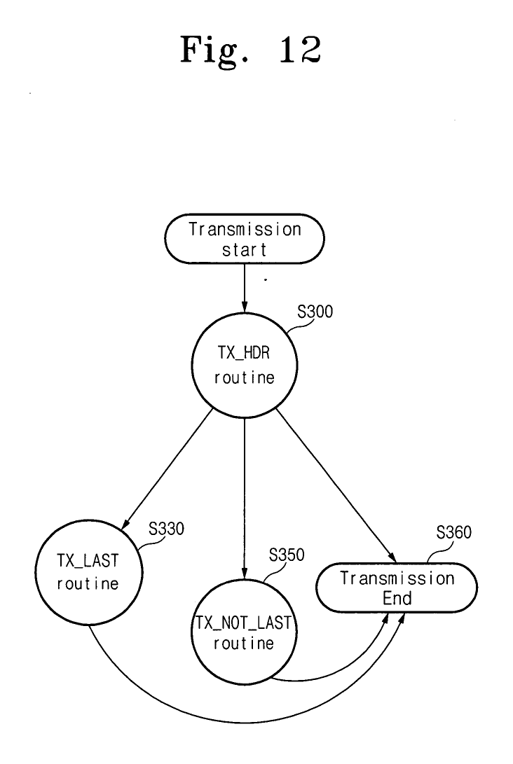

FIG. 12 is a flowchart illustrating encryption used for a transmission process that processes the high speed OCB mode according to another embodiment of the present invention. Like the flowchart of FIG. 6, such a transmission process can be programmed in a memory (not shown) of an E/D device, e.g., device 100, and can be run under the control of the control unit of the E/D device. The transmission process shown in FIG. 12 is similar to the reception process shown in FIGS. 6 to 11 excluding some functions. For example, the decipher function used during reception is replaced during transmission by the encipher function and the exception process routine is modified to bypass the checksum calculation if the current packet is a retry packet. The tag generating function used during reception is replaced during transmission with the MAC generating function. During transmission, the tag comparison function is not performed.

In FIG. 12, flow begins at step S300, where the header information transmission routine TX_HDR is performed. Subsequently, either a last block transmission routine TX_LAST is performed at step S340 or a transmission routine TX_NOT_LAST for a non-last block is performed at step S360. After either of steps S330 and S350, flow ends at step S360.

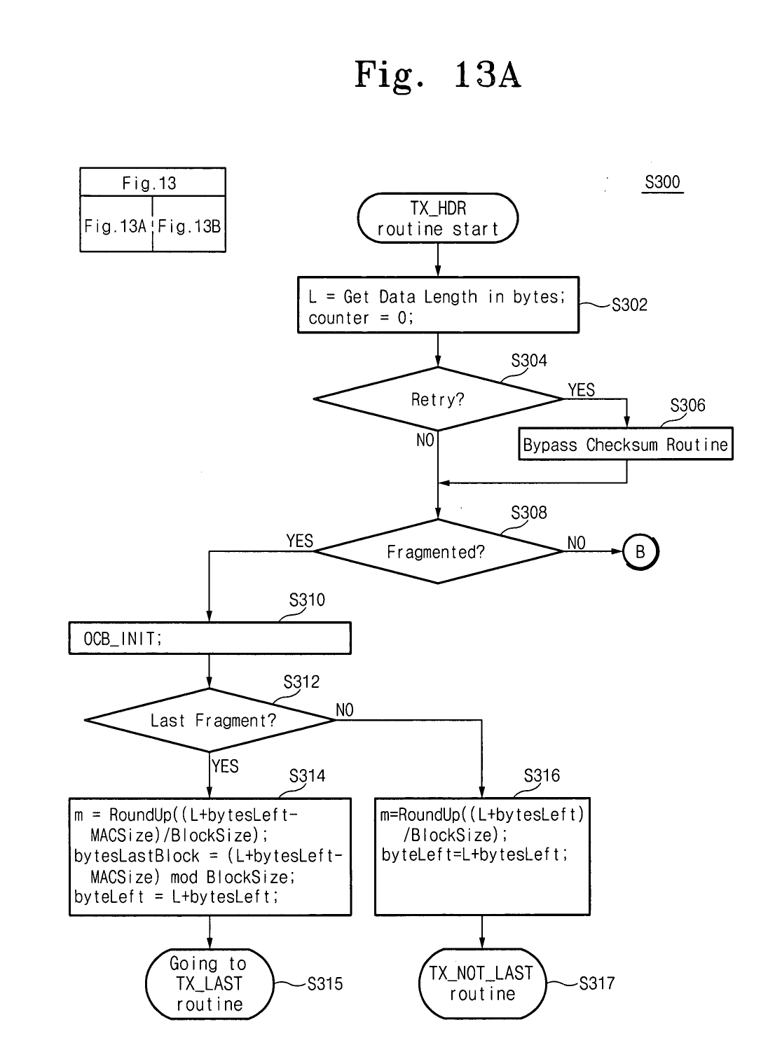

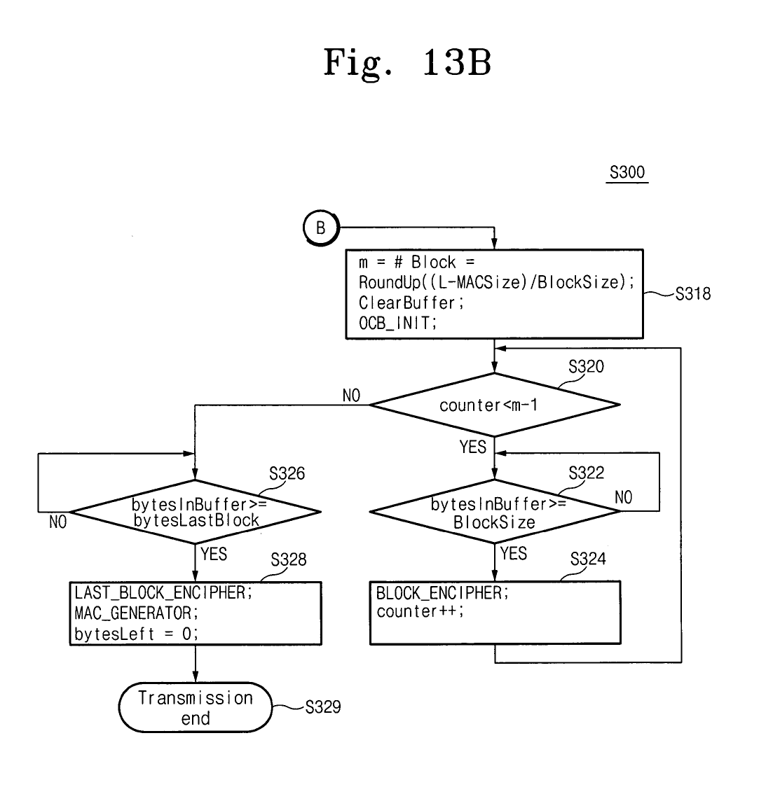

FIGS. 13A and 13B together are a flowchart showing in more detail an example of routine TX_HDR of step S300, according to another embodiment of the present invention. At step S302 of FIG. 13A, the length (in units of bytes) of the packet to be transmitted is calculated and variable COUNTER is initialized.

At decision step S304, it is determined whether the packet to be transmitted is a retry packet. If so, then the checksum value is neglected at step S306, (or, in other words, the checksum routine is bypassed) and then flow goes to decision step S308. If the packet to be transmitted is not a retry packet, then flow goes directly from decision step S304 to decision step S308. If so,

At decision step S308, it is determined whether the packet to be transmitted represents a fragment of a frame. If so, then flow goes to step S310, where the offset codebook initializing function is performed. But if not (at decision step S308), then flow goes to step S318 of FIG. 13B (to be discussed below).

Flow goes from step S310 to decision step S312, where it is determined whether the received packet is the last one of the fragments. If so, then flow it goes to step S314, where the number m of the blocks and the value (length) of variable BYTELASTBLOCK of the last block are calculated, and the number of bytes remaining in the buffer and the number of the bytes making up the packet to be received are summed and stored in variable BYTESLEFT. Subsequently at step S315, flow jumps to the last block processing routine TX_LAST of S330 (to be discussed below). If the packet is found at decision step S312 not to represent the last fragment, then flow goes to step S316. Step S316 is like step S314 except, e.g., that MACSIZE is not a factor in the equation for m. Subsequently at step S317, flow jumps to the routine TX_NOT_LAST of step S350 (to be discussed below).

Returning to decision step S308, if the packet represents an unfragmented frame, then flow goes to step S318 of FIG. 13B, where the number m of the blocks is calculated. Since the previously received packet may have been retained in the buffer, the buffer is flushed, the OCB mode initialization function is performed and the OCB mode is made ready. Flow goes from step S318 to decision step S320.

At decision step S320, it is determined whether the value of variable COUNTER is less than m−1. If so, then flow goes to decision step S322. At decision step S322, it is determined whether the length of data in the buffer, e.g., the value of variable BYTESINBUFFER, is greater than or equal to BLOCKSIZE. If so, then flow goes to step S324, where the block encipher function is performed to encrypt blocks. Subsequently, the value of variable COUNTER is increased by 1 and the flow goes back to step S320. Steps S320 to S324 are repeated until the value of variable COUNTER becomes equal to m−1.

If variable COUNTER equals m−1 at decision step S320, the flow goes to decision step S326. At decision step S326, it is determined whether variable BYTESINBUFFER is greater than or equal to variable BYTESLASTBLOCK. If so, then flow goes to step S328, where the last block cipher function is performed, the MAC generating function is performed and variable BYTESLEFT is initialized. Then the transmission is terminated at step S329.

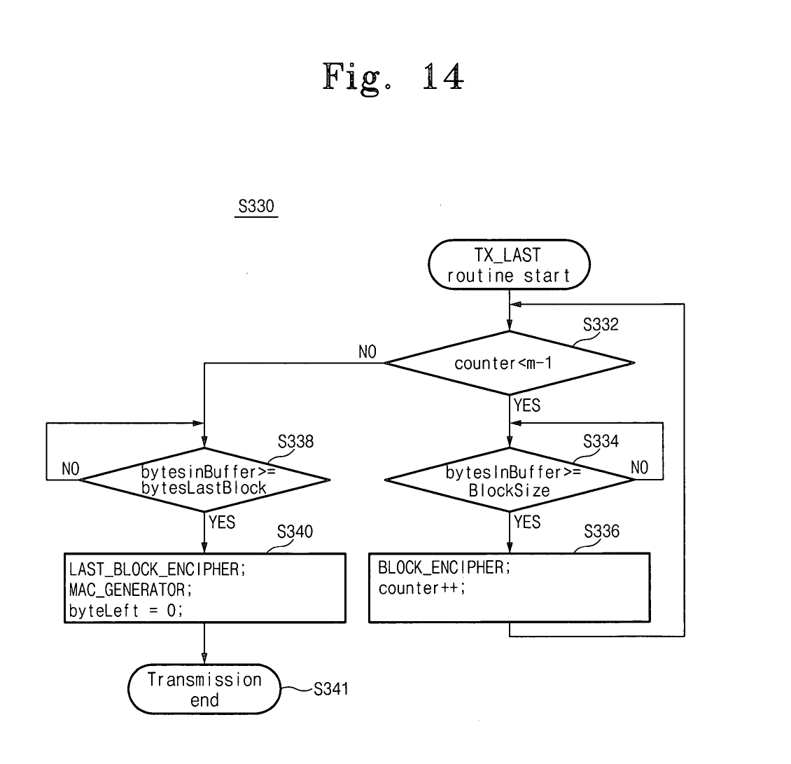

FIG. 14 is a flowchart showing in more detail an example of routine TX_LAST of step S330, according to another embodiment of the present invention. Flow starts at decision step S332, where it is determined whether variable COUNTER is less than m−1. If so, then flow goes to decision step S334. At decision step S334, it is determined whether variable BYTESINBUFFER is greater than or equal to variable BLOCKSIZE. If so, then flow goes to step S336, where the block encipher function is performed and variable COUNTER is increased by 1. Subsequently, flow goes back to step S332 SO that steps S332 to S336 are repeated until variable COUNTER becomes equal to m−1.

If variable COUNTER is m−1 at decision step S332, then flow goes to decision step S338. At decision step S338, it is determined whether variable BYTESINBUFFER is greater than or equal to variable BYTESLASTBLOCK. If so, then goes to step S340, where the last block encipher function is performed, the MAC generating function is performed and variable BYTESLEFT is initialized, e.g., to zero. Then the transmission is terminated at step S341.

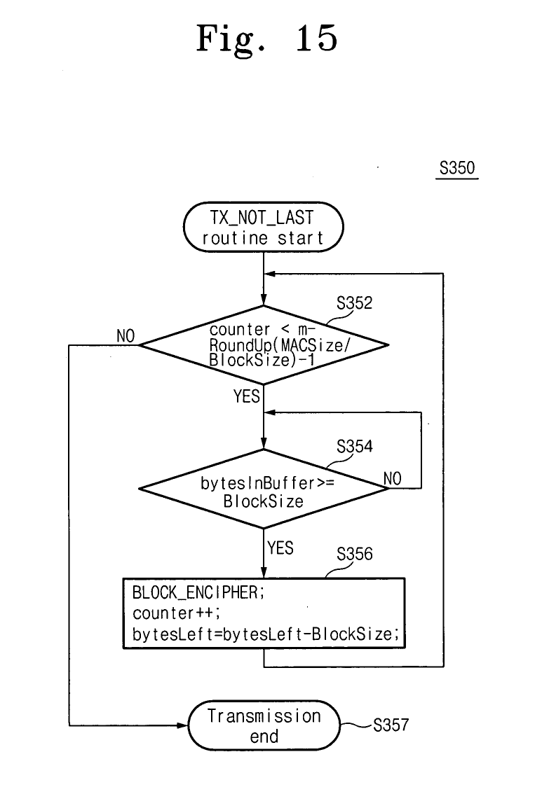

FIG. 15 is a flowchart showing in more detail an example of routine TX_NOT_LAST of step S350, according to another embodiment of the present invention. Flow begins at decision step S352, where it is determined whether the variable COUNTER is less than the difference m−RoundUp(MACSIZE/BLOCKSIZE)−1. If so, then flow goes to step S354. At decision step S354, it is determined whether variable BYTESINBUFFER is greater than or equal to variable BLOCKSIZE. If so, then flow goes to step S356, where the block encipher function is performed, variable COUNTER is increased by 1 and variable BYTESLEFT is decreased by variable BLOCKSIZE. Flow goes from step S356 back to step S352 so that steps S352 to S356 are repeated. But if variable COUNTER is found equal to the difference m−RoundUp(MACSIZE/BLOCKSIZE)−1 at decision step S352, the transmission is terminated at step S357.

As described above, an E/D device according to at least one embodiment of the present invention does the following.

It deals with a BLOCKFRAG exception by retaining one block in a buffer for the OCB mode used in transmitting and receiving the fragmented packet. Two or blocks of the size RoundUp(MACSIZE/BLOCKSIZE)+1 are retained in the buffer to deal with a MACFRAG exception. The received packet is ignored and the buffer is flushed to deal with a retry exception.

For reception, when storing the received packets, the checksum values are stored together so that a transmission exception can be dealt with by finding and using the previous value of the transmitter address. If the packet is a retry packet that already has been received, then the OCB mode is not performed on the retry packet as a way to deal with a retry exception. For transmission, if the packet is the retry packet, then the checksum calculation is bypassed while the OCB mode is performed as a way to deal with a retry exception.

According to at least one embodiment of the present invention, if an amount of data received in the buffer while transmitting or receiving a packet is less than or equal to BLOCKSIZE, then a corresponding portion of the OCB mode is performed with one block cipher or a plurality of block ciphers, so that encryption time can be reduced.

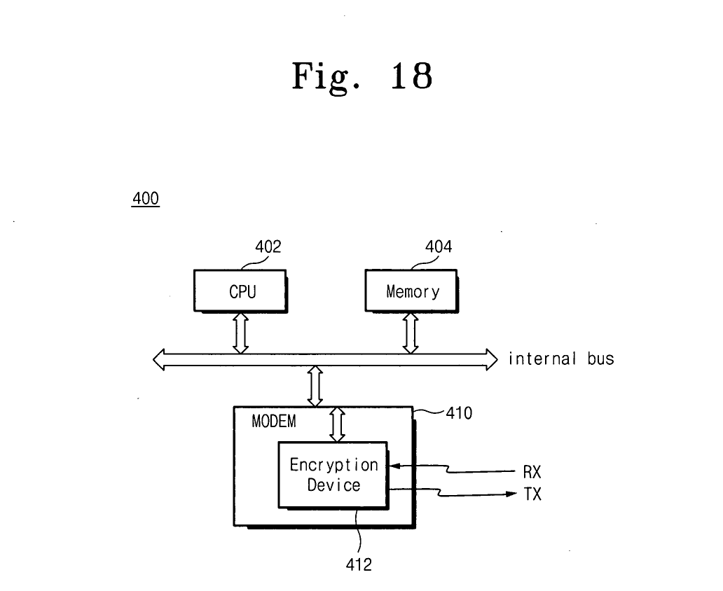

FIG. 18 is a block diagram illustrating a configuration of a mobile system 400, according to another embodiment of the present invention. Mobile system 400 includes a modem 410 that itself includes an E/D device 412. E/D device 412 can correspond to E/D device 100, etc. Mobile system 400 is also provided with components of the typical mobile system, for example, a central processing unit 402 and a memory 404. Mobile system 400 perform data communication via a wireless IAN.

E/D device 412 reads data out of memory 404, and encrypts and transmits the data in transmission, and decrypts the data and outputs the decrypted data to memory 404 in reception.

An E/D device according to at least one embodiment of the present invention can perform an encryption while transmitting and decryption while receiving a packet, so that transmission/reception times and encryption/decryption time can be overlapped with each other, the delay due to encryption/decryption can be reduced and the data security function can be provided without significant loss in data processing capability.

It will be apparent to those skilled in the art that various modifications and variations can be made to the present invention. Thus, it is intended that such modifications and variations come within the scope of the present invention.

What is claimed is:

1. An encryption device comprising:
an input circuit to fragment a received frame into two or more packets, and to controllably output each of the packets incrementally in the form of relatively smaller blocks of data;
a controller to receive information regarding the frame, to cause incremental release by the input circuit of the blocks, and to control encryption/decryption according to an offset codebook (OCB) mode;
an exception processing circuit to receive header information regarding the packets, to determine according to the header information whether an exception during encryption/decryption will occur due to fragmentation, and to provide the controller with the header information and information regarding an impending exception; and
a cryptoprocessing circuit to generate and store an offset codebook, a tag and a message authentication code (MAC), and based thereon to encrypt/decrypt the blocks according to the OCB mode.

2. The encryption device of claim 1, wherein the input circuit includes:
an input buffer to receive the frame and store it as two or more packets; and
an input bus controller to incrementally release blocks representing two or more packets, respectively, to the exception processing circuit and the cryptoprocessing circuit.

3. The encryption device of claim 1, wherein the cryptoprocessing circuit includes:
a block cipher engine to receive an encryption key from the controller and to process blocks for encryption/decryption;
a encryption processor to generate and store the offset codebook, the tag and the MAC, and to encrypt/decrypt the blocks coordination with the block cipher engine under control of the controller; and
an offset codebook memory to store the offset codebook.

4. The encryption device of claim 3, wherein:
the cryptoprocessing circuit further includes a checksum memory to store the checksum and a transmitter address; and
the encryption processor includes
an offset codebook initiator to generate a value of an initial entry in the offset codebook and store the initial entry in the offset codebook memory,
a block decipher to generate a next entry in the offset codebook based upon the previous entry in the offset codebook, to decrypt blocks other than a last block of the frame, and to update the checksum,
a last block decipher to generate a next entry in the offset codebook based upon the previous entry in the offset codebook, to decrypt the last block of the frame, and to update the checksum,
a tag generator operable during reception to generate a tag based upon the updated checksum,
a tag comparator operable during reception to compare the tag with the MAC, and to output and indication of whether an error occurs according to the comparison,
a block encipher to generate a next entry in the offset codebook based upon the previous entry in the offset codebook, to encrypted blocks other than a last block of the frame, and to update the checksum,
a last block cipher to generate a next entry in the offset codebook based upon the previous entry in the offset codebook, to decrypt the last block of the frame, and to update the checksum, and
a MAC generator to generate a MAC based upon the updated checksum.

5. The encryption device of claim 1, wherein the exception processing circuit includes:
a header information memory to store the header information;
a fragmentation exception processing circuit to receive the header information of a first packet from the input circuit, to recognize that a fragmentation exception will occur if a block or a MAC will be splintered, and to provide a determination result to the controller;
a transmission exception processing circuit to receive the header information from the header information memory and the input circuit, to recognize that a transmission exception will occur if a previous packet and a current packet were transmitted from different transmitters, and to provide a determination result to the controller; and
a retry exception processing circuit to recognize a retry exception will occur if one of a current received packet is a retry packet and the packet to be transmitted has an error, and to provide a determination result to the controller.

6. The encryption device of claim 5, wherein the controller is operable to control an encryption/decryption to begin while at least one block of a previous packet remains in the input circuit when there is an impending fragmentation exception.

7. The encryption device of claim 5, wherein the controller is operable to cause the input circuit to discard the current received packet when there is an impending transmission exception.

8. The encryption device of claim 5, wherein the controller is operable to control the next packet to be separately decrypted if a transmitter of the previous received packet is different than a transmitter of the current received packet.

9. The encryption device of claim 5, wherein the controller is operable to control the offset codebook mode not to be performed when there is an impending retry exception.

10. The encryption device of claim 5, wherein the controller is operable to control retransmission of a packet when there is an impending retry exception.

11. A method of encryption/decryption using an offset codebook (OCM) method during transmission/reception of packets in a data network, the method comprising:
receiving header information for at least a first packet of two or more packets representing a fragmented frame;
dividing each of the two or more packets into smaller blocks;
determining whether one of a fragmentation exception, a transmission exception and a retry exception will occur during encryption/decryption of the blocks based upon the header information; and
performing OCM mode encryption/decryption according to the determined exception.

12. The method of claim 11, wherein the performing of OCM mode encryption/decryption includes:
performing an encryption/decryption of a next packet while retaining at least one block of the previous packet if it is determined that the fragmentation exception will occur;
handling a transmission exception by decrypting a current received packet separately from decryption of a previous received packet and a currently received packet; and
handling a retry exception by discarding a current received packet if a retry exception is impending.

13. The method of claim 11, wherein:
the fragmentation exception occurs when a last block that forms a part of a packet or a MAC is splintered;
the performing OCM mode encryption/decryption includes
retaining the last block if a fragmentation exception is impending due to splintering the last block, and retaining the last block and at least one block preceding the last block if the MAC is splintered.

14. A method of block-level encryption/decryption for an offset codebook mode of operation during transmission/reception, the method comprising:
receiving a frame of data to encrypted/decrypted;
beginning to divide the frame into at least two packets before receipt of the frame is completed;
beginning to divide at least one of the packets into two or more blocks before receipt of the frame is completed;
releasing the blocks of the at least one packet for encryption/decryption before receipt of the frame is completed; and
enciphering/deciphering the blocks of the at least one packet before receipt of the frame is completed.

15. The method of claim 14, wherein all but the last block of the last packet is enciphered/deciphered before receipt of the frame is completed.

16. The method of claim 14, further comprising:
recognizing when one of a fragmentation exception, a transmission exception and a retry exception will occur;
wherein the enciphering/deciphering is varied when, and in accordance with, one of the fragmentation, transmission and retry exceptions is recognized as being impending.
